(19) United States
(12) Patent Application Publication
(10) Pub. No.: US 2026/0258225 A1
(43) Pub. Date: Sep. 3, 2026

(54) THERMALLY CONDUCTIVE MATERIAL AND METHOD OF MANUFACTURING SAME

(71) Applicant: KABUSHIKI KAISHA TOYOTA CHUO KENKYUSHO, Nagakute-shi, Aichi-ken (JP)

(72) Inventors: Junghwan HWANG, Nagakute-shi (JP); Yoshie OHIRA, Nagakute-shi (JP)

(73) Assignee: KABUSHIKI KAISHA TOYOTA CHUO KENKYUSHO, Nagakute-shi, Aichi-ken (JP)

(21) Appl. No.: 18/719,133

(22) PCT Filed: Apr. 21, 2023
(86) PCT No.: PCT/JP2023/015861

§ 371 Date: Jun. 12, 2024

(30) Foreign Application Priority Data
Oct. 31, 2022 (JP) 2022-175032

(51) Int. Cl. C08K 7/18

(52) U.S. Cl. CPC C08K 7/18; C08K 2201/001; C08K 2201/003; C08K 2201/019

(57) ABSTRACT

A thermally conductive material that is approximately isotropic and can achieve high thermal conductivity. A thermally conductive material including composite particles having approximately spherical base particles and flat adherent particles adhered to surfaces of the base particles via a resin. The composite particles may further have crosslinking particles having a larger particle diameter than the adherent particles on the surface side. The thermally conductive material may be a filler containing composite particles or a composite material containing the filler in a matrix. The composite particles are obtained, for example, by pressurizing a mixture in which approximately spherical first particles, flat second particles, and resin are mixed and pulverizing the compact. The composite particles may be produced by multi-stage mixing of approximately spherical first particles, flat second particles, third particles having a larger particle diameter than the second particles, and resin.

### TECHNICAL FIELD

The present invention relates to a thermally conductive material and relevant techniques.

### BACKGROUND ART

Elements, equipment, devices, etc. are increasing in the heat generation due to higher density and higher performance, and sufficient heat dissipation is required to ensure their functions, longer operating life, etc. For example, in the case of electronic equipment (such as semiconductor modules), heat is dissipated through heat dissipating materials with excellent thermal conductivity (heat sinks, casings, heat dissipating sheets (thermally conductive sheets), thermally conductive grease, etc.). In addition to single metals, composite materials with excellent moldability are often used as heat dissipating materials. Composite materials are usually composed of a filler with excellent thermal conductivity and a matrix (e.g., a resin containing an elastomer, rubber, etc.) that holds the filler.

As fillers, for example, ceramic particles (including fibers) such as silica (SiO₂), alumina (Al₂O₃), and aluminum nitride (AlN) have been used. However, these particles are approximately spherical, and therefore the contact ratio and contact area between the particles are small, thus making it difficult to form sufficient thermal conduction paths between the particles.

Recently, boron nitride (BN) particles, which are excellent in thermal conductivity, electrical insulation, chemical stability, etc., have been used as fillers. Types of boron nitride generally include a hexagonal normal pressure phase (which may be referred to as “h-BN”) and a cubic high pressure phase (which may be referred to as “c-BN”). Usually, h-BN particles are used as fillers. The h-BN particles are flat (scale-like, plate-like) particles in which hexagonal mesh layers similar to graphite are laminated. In general, the thermal conductivity in the plane direction (a-axis (100) direction) is larger than the thermal conductivity in the thickness direction (c-axis (002) direction) (thermal conduction anisotropy).

Furthermore, there have also been proposed fillers that contain a mixture of two or more types of particles with different particle diameters and/or thermal conductivity properties and composite materials filled with the fillers (i.e., the fillers are dispersed or encapsulated therein). For example, relevant descriptions are found in the following patent documents.

### PRIOR ART DOCUMENTS

### Patent Documents

Patent Document 1: JP2008-106231A
Patent Document 2: JP2011-184507A
Patent Document 3: JP2019-43804A

### SUMMARY OF INVENTION

### Technical Problem

Patent Document 1 proposes an adhesive sheet (composite material) for electronic equipment in which a powder (filler) that is a simple mixture of boron nitride powder and spherical alumina powder is mixed in an epoxy resin (matrix) ([0056], Example 9 of Table 1). Its thermal conductivity remains at most 3.6 W/mK.

Patent Document 2 proposes a sheet (composite material) in which a powder (filler) that is a simple mixture of alumina, boron nitride, and aluminum nitride is mixed in a silicone resin (matrix) ([0027], Table 4). Its thermal conductivity remains at most 7.2 W/mK.

Patent Document 3 proposes forming composite particles (filler) through hot pressing (40 MPa×1800° C.×2 hours) a mixed powder composed of boron nitride particles and aluminum nitride particles under a nitrogen atmosphere to obtain a compressed sintered body and subjecting it to preliminary pulverization using a hammer and a mortar and wet impact pulverization using high-pressure nozzle injection. When molding a thermally conductive composite material in which the composite particles are mixed in an epoxy resin (matrix), its thermal conductivity in the compression direction (z direction) during the molding remains at most 4 W/mK while its thermal conductivity in the orthogonal direction (x direction) remains at most 5.9 W/mK

The present invention has been made in view of such circumstances, and an object of the present invention is to provide a novel thermally conductive material and relevant techniques.

### Solution to Problem

As a result of intensive studies to achieve the above object, the present inventors have newly found that composite particles in which flat particles are adhered (bonded, glued) to approximately spherical particles with a resin can develop high thermal conductivity almost isotropically. By developing this achievement, the present inventors have accomplished the present invention, which will be described below.

### «Thermally Conductive Material» (1)

The present invention provides a thermally conductive material including composite particles having approximately spherical base particles and flat adherent particles adhered to surfaces of the base particles via a resin.

According to the present invention, it is possible to approximately isotropically improve the thermal conductivity of a filler that contains at least composite particles (one form of the thermally conductive material) or a composite material that contains the filler (another form of the thermally conductive material). Although the reason for this is not clear, it is considered to be due to the form (structure) of the composite particles according to the present invention. That is, the composite particles according to the present invention are not only in a state in which the approximately spherical particles and the flat particles are mixed together or in contact with each other, but also in a state in which the flat adherent particles are adhered to the outer surfaces of the approximately spherical base particles via a resin (layer). In other words, the composite particles are in a state in which a plurality of flat adherent particles are in planar and close contact with each other in various directions around the approximately spherical outer surfaces of the base particles. Accordingly, the composite particles have an increased opportunity of coming into contact with each other in various directions (even surface contact) via the adherent particles, and sufficient thermal conduction paths can be formed approximately isotropically. As a result, the thermally conductive material of the present invention is considered to develop the above-described excellent thermal conductivity.

(2) The composite particles according to the present invention may further have crosslinking particles with a larger particle diameter than the adherent particles on the (outmost) surface side. The crosslinking particles increase the opportunity of contact between the composite particles and promote the formation of the above-described thermal conduction paths. This can further improve the thermal conductivity properties of the thermally conductive material.

### «Method of Manufacturing Thermally Conductive Material»

(1) The present invention can also be conceived as a method of manufacturing a thermally conductive material. For example, the present invention may provide a method of manufacturing a thermally conductive material, comprising: a preparation step of obtaining a mixture in which approximately spherical first particles, flat second particles, and a resin are mixed; a molding step of pressurizing the mixture to obtain a compact; and a pulverization step of pulverizing the compact, wherein composite particles are obtained in which the second particles (adherent particles) are adhered to surfaces of the first particles (base particles) by the resin.

The molding step is preferably performed in a state in which the resin in the mixture easily flows or infiltrates between the particles (e.g., in a state in which the resin is softened or melted). If the resin is in a solidified state or in a state of being difficult to flow during the molding, it may be heated and molded (i.e., warm molding).

(2) The present invention may also provide, for example, a method of manufacturing a thermally conductive material, comprising: a first mixing step of obtaining a first mixture in which approximately spherical first particles and a resin are mixed; and a second mixing step of obtaining a second mixture in which the first mixture and flat second particles are mixed, wherein composite particles are obtained in which the second particles are adhered to surfaces of the first particles by the resin.

Composite particles in which the first particles and the second particles are in close contact with each other via the resin can be obtained by performing only the mixing step without performing the molding step. When the resin is a thermosetting resin, by heating the second mixture, the resin that bonds the first particles and the second particles can be cured (thermal curing step). This allows a filler to be obtained in which the first particles and the second particles are firmly adhered with the thermosetting resin.

(3) The present invention may also provide, for example, a method of manufacturing a thermally conductive material, comprising: a first mixing step of obtaining a first mixture in which approximately spherical first particles and a resin are mixed; a second mixing step of obtaining a second mixture in which the first mixture and flat second particles are mixed; and a third mixing step of obtaining a third mixture in which the second mixture and third particles having a larger particle diameter than the second particles are mixed, wherein composite particles are obtained in which the second particles are adhered to surfaces of the first particles by the resin and the third particles are attached to the (outermost) surface side.

A resin may be further mixed in the third mixture. This allows the third particles to also positively adhere to the second particles, etc. via the resin. When using a thermosetting resin, a thermal curing step for the thermosetting resin may be carried out as appropriate. The thermal curing step may be performed both after the second mixing step and after the third mixing step or only after one of them (in particular, after the third mixing step).

(4) The above-described first mixing step and second mixing step may be combined (merged) and performed. For example, the present invention may provide a method of manufacturing a thermally conductive material, comprising: a mixing step of obtaining a mixture in which approximately spherical first particles, flat second particles, and a resin are mixed (the mixing step may be referred to as a “fourth mixing step) (the mixture may be referred to as a “fourth mixture”), wherein composite particles are obtained in which the second particles are adhered to surfaces of the first particles by the resin. The above-described third mixing step may be performed after the mixing step.

The above-described first mixing step, second mixing step, and third mixing step may also be combined (merged) and performed. For example, the present invention may also provide a method of manufacturing a thermally conductive material, comprising: a mixing step of obtaining a mixture in which approximately spherical first particles, flat second particles, third particles having a larger particle diameter than the second particles, and a resin are mixed (the mixing step may be referred to as a “fifth mixing step) (the mixture may be referred to as a “fifth mixture”), wherein composite particles are obtained in which the second particles and the third particles are adhered to surface sides of the first particles by the resin.

When using a thermosetting resin, a thermal curing step for the thermosetting resin may be carried out as appropriate. The thermal curing step may be performed for each mixing step or may also be performed only after any mixing step (in particular, after the final mixing step).

### «Composite Material/Thermally Conductive Member»

The thermally conductive material of the present invention can be perceived not only as a filler (one form of the thermally conductive material) containing at least composite particles but also as a composite material (another form of the thermally conductive material) in which at least composite particles are dispersed in a matrix (or binder) or as a thermally conductive member (still another form of the thermally conductive material) composed of the composite material.

It is sufficient that the matrix can encapsulate or support (including holding) the composite particles, and the matrix is not limited to a solid, but may be a semi-solid (semi-fluid), a liquid (fluid), or the like. For example, the thermally conductive material (composite material) of the present invention may be a solid such as a heat dissipating member, a substrate, a case, a sheet, or a film or a (semi-) liquid (fluid) such as oil or grease. In the present specification, such composite materials are also collectively referred to as “thermally conductive members” in a simple word regardless of their state.

When crosslinking particles are used, the crosslinking particles become a part (constituent element) of the composite particles, and may also be considered as a separate filler independent of the composite particles. For example, considering a composite filler in which crosslinking particles and composite particles with adherent particles adhered to base particles are mixed without attachment (adhesion), a composite material and a thermally conductive member in which the composite filler is dispersed in a matrix, etc., they may also be perceived as the thermally conductive materials of the present invention.

«Others»

(1) As used in the present specification, a “ . . . material” means a “material or a “member.” For example, the thermally conductive material may be composite particles themselves, a filler containing composite particles, an aggregate thereof (powder), or the like, may be a tangible or intangible composite material (including a raw material) composed of composite particles or a filler (such as particles or powder) and a parent material (matrix, binder), or may be a tangible member or the like obtained by processing a raw material composed of a composite material into a desired shape.

(2) Unless otherwise stated, a numerical range “x-y” as referred to in the present specification includes the lower limit x and the upper limit y. Any numerical value included in various numerical values or numerical ranges described in the present specification may be selected or extracted as a new lower or upper limit, and any numerical range such as “a-b” can thereby be newly provided using such a new lower or upper limit. Unless otherwise stated, a range “x-y μm” as referred to in the present specification means x μm to y μm. The same applies to other unit systems (such as W/mK and (m).

### BRIEF DESCRIPTION OF DRAWINGS

FIG. 1 is a schematic diagram illustrating an example of production steps for composite particles.

FIG. 2A is an SEM image of a cross section of a compact obtained in the production process for a filler (composite particles) of Sample 1.

FIG. 2B is a set of SEM images of the composite particles according to Sample 1.

FIG. 2C is a set of a SEM image and an EDX analysis image of the composite particle.

FIG. 3 is a set of SEM images of a filler of Sample CO.

FIG. 4 is a bar graph comparing the thermal conductivity of composite materials.

FIG. 5 is a bar graph illustrating the relationship between the particle diameter ratio (h-BN/AlN) of composite particles and the thermal conductivity of the composite materials.

FIG. 6 is a set of schematic diagrams illustrating the influence of the form of filler on the formation of thermal conduction paths.

FIG. 7 is a schematic diagram illustrating another example of production steps for composite particles.

FIG. 8A is a SEM image of composite particles according to Sample 31.

FIG. 8B is a SEM image of composite particles according to Sample 41.

FIG. 9A is a bar graph comparing the thermal conductivity of composite materials (base particles: AlN).

FIG. 9B is a bar graph comparing the thermal conductivity of composite materials (base particles: Al₂O₃).

FIG. 10 is a schematic diagram illustrating still another example of production steps for composite particles.

FIG. 11 is a graph comparing the thermal conductivity and porosity of composite materials containing different fillers.

FIG. 12 is a set of SEM images when observing cross sections of those composite materials.

FIG. 13 is a set of schematic diagrams illustrating cross sections of those composite materials.

### EMBODIMENTS FOR CARRYING OUT THE INVENTION

One or more features freely selected from the present specification can be added to the features of the present invention. The content described in the present specification may apply not only to thermally conductive materials (such as composite particles, fillers, composite materials, and members), but also to methods of manufacturing the same, etc. Methodological features can also be features regarding a product. Which embodiment is the best or not is different in accordance with objectives, required performance, and other factors.

### «Composite Particles»

The composite particles include at least base particles (first particles), adherent particles (second particles), and a resin. The composite particles may further include crosslinking particles (third particles). Each particle may be an aggregated secondary particle. The composite particles or the filler containing the composite particles may include non-adhered base particles, adherent particles, and crosslinking particles. The filler or the composite material may further include other particles (e.g., particles composed of graphite (including carbon black), diamond, nanocarbon (carbon nanotubes (CNTs), carbon nanohorns (CNHs), fullerenes, graphene, etc.).

In the present specification, raw material particles that become base particles will be referred to as first particles, raw material particles that become adherent particles will be referred to as second particles, and raw material particles that become crosslinking particles will be referred to as third particles. The particle shape may change before and after preparation into composite particles.

### (1) Particle Shape

The base particles (first particles) are approximately spherical, and the adherent particles are flat. The shape of the crosslinking particles is, for example, plate-like, flat-like, fibrous, or the like.

“Approximately spherical” means, for example, that the circularity determined from an observed image (e.g., a SEM image) of a base particle is 0.6 or more in an embodiment or 0.7 or more in another embodiment. Although the theoretical upper limit of circularity is 1, the practical upper limit is 0.98 or less.

The circularity is determined as 4S/πL² from the maximum length (L) of a particle and its area(S). Specifically, the circularity can be obtained by image processing the observed image using software (such as ImageJ). Usually, the arithmetic mean value of the circularities obtained for a number of particles within a field of view (650 μm×450 μm) may be employed as the “circularity” as referred to in the present specification.

“Flat” means, for example, that the aspect ratio (L/t), which is the ratio of the maximum particle length (L) to the minimum particle length (t), is 3-300 in an embodiment (or 20-200 in another embodiment). The minimum length (t) and maximum length (L) of a particle are determined from the above-described observed image. Usually, the arithmetic mean value of the aspect ratios obtained for a number of particles within the above-described field of view may be employed as the “aspect ratio” as referred to in the present specification. “Plate-like,” “fibrous,” etc. can also be considered in the same way as the “flat.”

### (2) Particle Diameter Ratio

The particle diameter ratio (L2/L1), which is the ratio of the particle diameter (L2) of the adherent particles to the particle diameter (L1) of the base particles, is, for example, 0.01-2 in an embodiment, 0.04-1 in another embodiment, 0.08-0.5 in still another embodiment, or 0.1-0.3 in yet another embodiment. If the particle diameter ratio is unduly small, the thermal conductivity of the thermally conductive material may decrease. If the particle diameter ratio is unduly large, it will be difficult for the adherent particles to adhere to the outer surfaces of the base particles.

The particle diameter (L3) of the crosslinking particles is preferably larger than the particle diameter (L2) of the adherent particles (L2<L3). The particle diameter ratio (L3/L2), which is the ratio of the particle diameter (L3) of the crosslinking particles to the particle diameter (L2) of the adherent particles, is, for example, 1.1-20 in an embodiment, 1.4-15 in another embodiment, or 3-10 in still another embodiment. If the particle diameter ratio is unduly small or unduly large, the cooperation between the composite particles due to the crosslinking particles may deteriorate. The adherent particles and the crosslinking particles usually have smaller particle diameters than the base particles (L2<L1, L3<L1).

The “particle diameter” as referred to in the present specification is the maximum length (L) of the particles. The particle diameter is determined from the above-described observed image. For a number of particles, the arithmetic mean value of the particle diameters of particles within the field of view (650 μm×450 μm) may be employed as the “particle diameter” as referred to in the present specification. In the present specification, the particle size is simply referred to as the “particle diameter” regardless of the shape of the particles (such as approximately spherical, flat, scale-like, plate-like, fibrous, or long spheroidal).

The particle diameter of the particles constituting the composite material or composite particles can be calculated in the same manner as described above for particles separated/extracted from the composite material or composite particles.

For the particle diameter of the raw material powder (first particles, second particles, or third particles), a 50% diameter (D50: median diameter) determined from the particle diameter distribution obtained by laser diffraction may be alternatively employed.

The particle diameter of each particle itself is not limited. Suffice it to say that the particle diameter of the base particles is, for example, 10-200 μm in an embodiment, 20-150 μm in another embodiment, 35-120 μm in still another embodiment, or 40-95 μm in yet another embodiment. The particle diameter of the adherent particles is, for example, 2-100 μm in an embodiment, 4-75 μm in another embodiment, 8-50 μm in still another embodiment, or 15-35 μm in yet another embodiment. The particle diameter of the crosslinking particles is, for example, 5-150 μm in an embodiment, 10-100 μm in another embodiment, or 15-50 μm in still another embodiment.

### (3) Volume Ratio

The base particles have a volume ratio (which may be referred to as a “first volume ratio”) to the total amount of the base particles and adherent particles (which may be referred to as a “first total amount”), for example, of 0.5-0.9 in an embodiment, 0.6-0.85 in another embodiment, or 0.7-0.82 in still another embodiment. When crosslinking particles are contained, the base particles have a volume ratio (which may be referred to as a “second volume ratio”) to the total amount of the base particles, adherent particles, and crosslinking particles (which may be referred to as a “second total amount”), for example, of 0.4-0.85 in an embodiment, 0.5-0.8 in another embodiment, or 0.6-0.76 in still another embodiment. The volume ratio of the crosslinking particles to the adherent particles (which may be referred to as a “third volume ratio”) is, for example, 0.1-2 in an embodiment, 0.2-1.5 in another embodiment, or 0.3-1 in still another embodiment. If each volume ratio is unduly small or unduly large, the thermal conductivity or its isotropy may decrease.

The volume of a particle is calculated, for example, from its mass (content) and its true density. The volume ratio is calculated from the volume calculated for each particle. In the case of a particle constituting the composite material or composite particles, the same calculation may be performed for the particle after separation/extraction. The volume at the time of preparation can be calculated from the compounding amount (mass) of each raw material powder and its true density.

### (4) Coverage

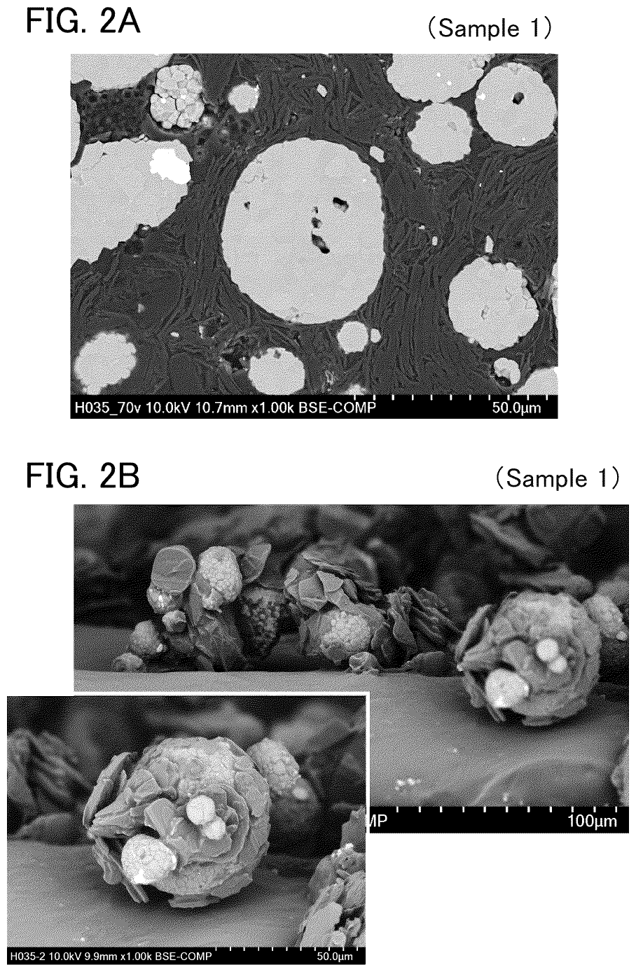

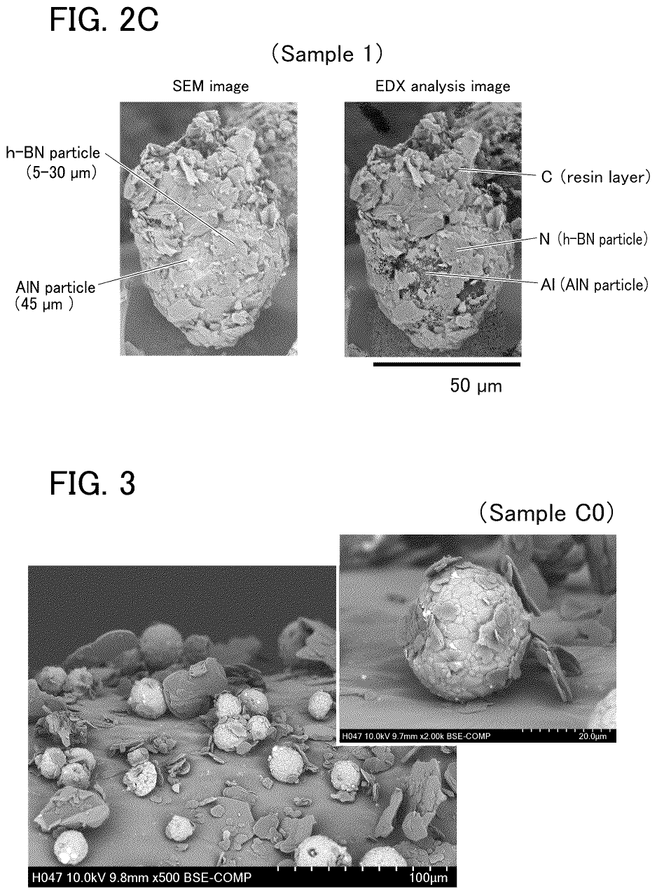

At least a portion of the composite particles preferably has a proportion of the surface area of the base particles covered with the adherent particles (referred to as a “coverage”), for example, of 50% or more in an embodiment, 60% or more in another embodiment, or 70% or more in still another embodiment. If the coverage is unduly low, the thermal conductivity and its isotropy may decrease. The coverage is determined as follows. The surfaces of the composite particles are observed using SEM/EDX to measure the component amount of the base particles and the component amount of the adherent particles. The coverage is defined as (component amount of adherent particles)/{(component amount of base particles)+ (component amount of adherent particles)}. For example, as illustrated in the SEM/EDX images of FIG. 2C, in the case of the composite particles in which AlN particles are covered with h-BN particles, the coverage is determined as the N amount/(Al amount+N amount) from the Al amount (component amount of base particles) and the N amount (component amount of adherent particles) obtained from the surface of one particle. An arithmetic mean value of coverages obtained for several particles may also be employed.

### (5) Material Quality

Preferably, the material quality of the base particles (first particles) and adherent particles (second particles) is highly thermally conductive. Examples of the base particles include approximately spherical particles composed of one or more of aluminum nitride (such as AlN), aluminum oxide (such as Al₂O₃), silicon oxide (such as SiO₂), cubic boron nitride (c-BN), and the like. As the adherent particles or crosslinking particles, there are flat particles or plate particles composed of hexagonal boron nitride (h-BN). In the case of a thermally conductive material used for electronic equipment, etc., both the base particles and the adherent particles are preferably composed of insulating materials.

### (6) Resin

The resin used for adhesion (resin layer, adhesive layer) may be composed of a thermoplastic resin or a thermosetting resin. The thermosetting resin may be subjected to thermal curing treatment as appropriate. The thermally cured resin layer brings the base particles (first particles), the adherent particles (second particles), or the crosslinking particles (third particles) into a stronger and closer state.

It is sufficient that the resin can adhere between particles. The resin may be present in an amount, for example, of 0.1-5 mass % in an embodiment, 0.3-3.5 mass % in another embodiment, or 0.5-2.5 mass % in still another embodiment with respect to the entire composite particles. In terms of the volume proportion to the entire composite particles, the resin may be, for example, 1-45 vol % in an embodiment, 5-40 vol % in another embodiment, 10-35 vol % in still another embodiment, or 15-30 vol % in yet another embodiment. The resin constituting the composite particles may be the same as or different from the resin constituting the matrix of the composite material, which will be described below.

### «Composite Material»

The composite material is composed of a filler that contains at least the composite particles and a matrix (including a binder) that supports, holds, or disperses the filler.

### (1) Filler

The filler is contained, for example, in an amount of 50-95 vol % in an embodiment, 55-85 vol % in another embodiment, or 60-80 vol % in still another embodiment with respect to the entire composite material. If the filling rate of the filler is unduly low, the thermal conductivity of the composite material may also decrease. Even if the filling rate of the filler is increased too much, the thermal conductivity of the composite material may not necessarily increase.

The filling rate (vol %) of the filler at the time of manufacturing the composite material is specified from the compounding amount and density of the raw materials. The filling rate of the filler in the composite material is specified from the total amount of the composite material and the amount of filler separated from the composite material. When the filler cannot be separated, the filling rate of the filler may be specified indirectly or alternatively from an observed image (such as SEM image) of the composite material (cross section).

All or part of the filler is preferably surface-treated to increase its affinity with the matrix. Surface treatment can improve the dispersibility, filling properties, interfacial adhesion, etc. of the filler in the matrix, and can improve the thermal conductivity of the composite material.

The surface treatment is, for example, a hydrophobic treatment or a coupling treatment. When the matrix is an organic material (such as resin or rubber/elastomer), for example, silane coupling treatment, fluorine plasma treatment, etc. may be performed. The silane coupling treatment can be performed using various silane coupling agents having reactive groups corresponding to the functional groups (such as amino group, epoxy group, isocyanate group, vinyl group, and acrylic group) on the matrix side. A typical silane coupling agent is, for example, hexamethyldisilazane (HMDS: C₆H₁₉NSi₂). The silane coupling agent has a reactive group (such as silyl group) that also corresponds to a functional group (such as hydroxyl group, methoxy group, or ethoxy group) on the side of filler (such as composite particles), which is usually an inorganic material.

The content (compounding amount/additive amount) of the surface treatment agent is, for example, 0.1-3 mass parts in an embodiment, 0.5-2.5 mass parts in another embodiment, or 1-2 mass parts in still another embodiment with respect to 100 mass parts of the entire filler before treatment. If the content of the surface treatment agent is unduly small, its effect will be poor, while even if the content of the surface treatment agent is increased too much, the effect will not improve much.

The surface treatment may be performed on the filler before mixing (including kneading) or may also be performed by addition or the like of a surface treatment agent (such as a coupling agent) at the time of mixing the matrix and the filler.

### (2) Matrix

The matrix (including a binder) is, for example, a resin or an oil/fat (including a resin-based oil, semi-solid grease, etc.). The resin (including rubber/elastomer, etc.) may be a thermosetting resin or a thermoplastic resin. Examples of the thermosetting resin include epoxy resin, phenol resin, and silicone resin. Examples of the thermoplastic resin include polystyrene, polymethyl methacrylate, polycarbonate, and polyphenylene sulfide. Examples of the rubber include ethylene-propylene-diene rubber (EPDM) and butyl rubber. Examples of the oil/fat include silicone oil and silicone grease.

### «Manufacturing Method»

### (1) Composite Particles

Various methods can be considered for manufacturing composite particles in which flat second particles (adherent particles) are adhered to approximately spherical first particles (base particles) with a resin (binder, adhesive). For example, the composite particles can be obtained by disintegrating a mixture (including a kneaded product) of the first particles, the second particles, and the resin, by pulverizing a compact of the mixture, or by performing other similar processing. This will be more specifically described below.

The mixture is obtained, for example, by mixing (including kneading) the first particles (powder), the second particles (powder), and the resin. Such mixing is performed using a ball mill, a vibration mill, a V-type mixer, etc. (preparation step). In this operation, the second particles in a laminated state may be pulverized. The mixing may be dry or wet mixing. The mixture obtained by wet mixing may be dried in vacuum, dried by heating, etc., as appropriate.

Mixing of the first particles (powder), the second particles (powder), and the resin (preparation step) may be performed in a stepwise manner. For example, a first mixing step of obtaining a first mixture in which the first particles and the resin are mixed and a second mixing step of obtaining a second mixture in which the second particles are added to and mixed with the first mixture may be performed in sequence. This allows the second particles to efficiently adhere to the first particles while suppressing the amount of resin.

The mixing step may be performed by adding a solvent or the like to adjust the viscosity of the resin. In this case, after the second mixing step, a drying step may be performed to volatilize/evaporate the solvent or the like. When using a thermosetting resin, a thermal curing step in which the second mixture is heated to cure the resin between the first particles and the second particles may be performed at the composite particle manufacturing stage (before the composite material manufacturing stage).

Other than performing disintegration, pulverization, etc. of the mixture without any modification, a compact obtained by pressure molding the mixture may be subjected to pulverization or the like (pulverization step). A powder composed of composite particles (referred to as a “composite powder”) is obtained by disintegration, pulverization, or the like. For the pulverization, for example, a small pulverizer, a crusher machine, a cutter mill, etc. are used.

The compact can be obtained, for example, by molding the mixture with a mold, CIP (Cold Isostatic Pressing), RIP (Rubber Isostatic Pressing), HIP (Hot Isostatic Pressing), etc. (molding step). The molding pressure is, for example, 10-100 MPa in an embodiment or 20-50 MPa in another embodiment. It is sufficient that the compact has a shape that can be pulverized.

The molding step may be cold molding performed at ordinary temperature (room temperature) or warm molding performed by heating the mixture or a mold. Warm molding is preferably performed, for example, at a temperature at which the resin softens or melts. This allows the resin to be readily interposed between the first particles and the second particles while suppressing the amount of resin. The temperature (T) of warm molding is, for example, within a difference range of −30-30° C. (|T−(Ts, Tm)|≤30° C.) in an embodiment or −20-20° C. (|T−(Ts, Tm)|≤20° C.) in another embodiment with respect to the softening point (Ts) or melting point (Tm) of the resin. Suffice it to say that although depending on the type of resin, the warm molding temperature (usually the mold temperature) is, for example, 80-200° C. in an embodiment or 100-160° C. in another embodiment. The warm molding time is, for example, 5-60 minutes in an embodiment or 15-40 minutes in another embodiment. When using a thermosetting resin, the warm molding step may also serve as a thermal curing step.

The composite powder may be subjected to granularity adjustment to have an average particle diameter (median diameter: D50), for example, of 5-60 μm in an embodiment or 15-55 μm in another embodiment.

### (2) Composite Material

The composite material is obtained by mixing, kneading, molding, etc. of a filler and a matrix. The composite material in which the filler is held by the resin can be obtained, for example, by compression molding, injection molding, transfer molding, etc., of the mixture. When the matrix is a thermosetting resin, a thermal curing treatment (cure treatment) may be performed after its molding. The composite material may be in the shape of a final product or a shape close to it or may also be a raw material, an intermediate material, or the like to be processed.

### «Use Application»

Fillers and composite materials are used, for example, in heat dissipating members (heat dissipating sheets, substrates, cases, etc.) and oils/fats (such as oil and grease). The thermal conductivity of the composite material can be, for example, 8-40 W/mK in an embodiment or 10-25 W/mK in another embodiment. Depending on the type of adherent particles and their degree of orientation, the thermally conductive material of the present invention can have a difference in the thermal conductivities in two orthogonal directions, for example, of 6 W/mK or less in an embodiment, 4 mK or less in another embodiment, or 2 W/mK or less in still another embodiment. The composite material used for electronic equipment and the like preferably has a specific resistance, for example, of 10⁵-10¹² Ωm in an embodiment or 10⁸-10¹⁰ Ωm in another embodiment.

### EXAMPLES

Various composite materials with different fillers dispersed in matrices were produced, and their thermal conductivity properties were evaluated. The present invention will be described in more detail by exemplifying such specific examples.

### First Example

### «Production of Fillers»

Multiple types of fillers illustrated below were produced.

(1) Sample 1 (Composite particles)

Commercially available AlN powder (FAN-f50 available from Furukawa Denshi Co., Ltd.), h-BN powder (PT110 available from Momentive Performance Materials), and an epoxy resin (EP-160 available from CEMEDINE CO., LTD./one-component thermosetting epoxy-based adhesive) were prepared as raw materials. This epoxy resin was in a liquid state with high viscosity in a room temperature region.

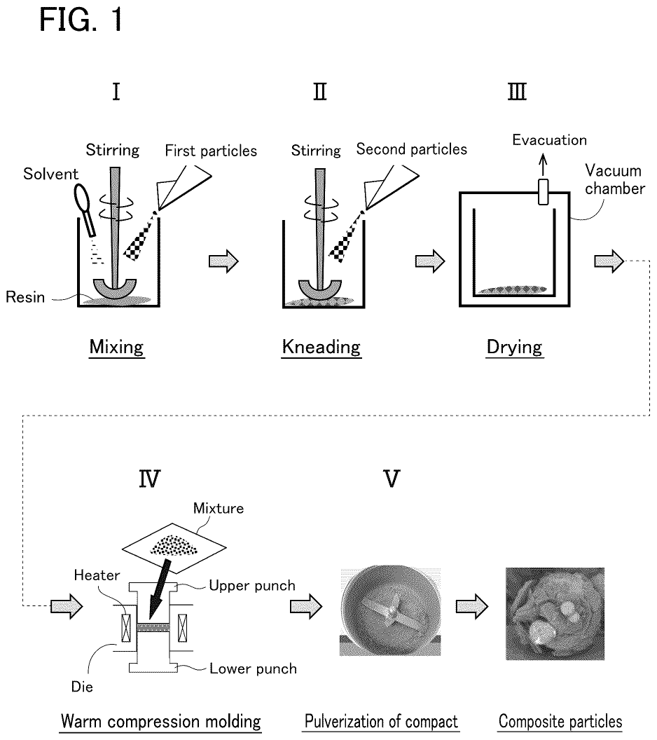

The AlN powder was composed of spherical particles (first particles) with a circularity of 0.90 and a particle diameter (D50) of 45 μm. The h-BN powder was pulverized into a cleaved powder using a pulverizer (Star Burst HJP-25008 available from Sugino Machine Limited). This cleaved powder was composed of flat particles (second particles) with an aspect ratio (AR=maximum length L/thickness t) of 40 and a particle diameter (D50) of 20 μm (particle diameter ratio: 0.44). Each step illustrated in FIG. 1 was performed using these raw materials to prepare composite particles. Specifically, it is as follows.

In a polypropylene container, 1-10 cc of solvent (dichloromethane) and 3.85 g of AlN powder were added to 0.25 g of epoxy resin, and they were mixed (Step I/Mixing step). Mixing was performed at room temperature using a mixer (ARE-310 “Rentaro” available from THINKY CORPORATION) at 2000 rpm×0.5 min.

To the mixture, 1.15 g of the h-BN cleaved powder was added, and they were kneaded (Step II/Kneading step). Kneading was performed at room temperature using the above-described device without any modification at 2000 rpm×0.5 min.

The obtained kneaded product was placed in a vacuum chamber and vacuum dried (30 minutes) at room temperature (Step III/Drying step). A mixture (kneaded product) was thus obtained, from which the solvent was evaporated. The true density of AlN particles is 3.3 g/cm³, the true density of h-BN particles is 2.27 g/cm³, and their volume fractions correspond to AlN particles (first particles): h-BN particles (second particles)=7:3 (volume ratio of the adherent particles to the total of both particles: 0.3). The epoxy resin (true density: 1.16 g/cm³) corresponds to 30 vol % with respect to the entire mixture.

The mixture was put into the cavity of a mold composed of a die and upper and lower punches and warm compression molded in the uniaxial direction (Step IV/Molding step). In this operation, the temperature of the mold (die) heated with a heater was 130° C., and the molding pressure was 35 MPa. The temperature at which the epoxy resin after drying was softened or melted was 80° C.

The compact (12 mm×12 mm×15 mm) taken out from the mold was pulverized using a tabletop crusher (available from AS ONE CORPORATION) (Step V/Pulverization Step). The pulverized powder was sieved to adjust the granularity to less than 53 μm. Composite particles were thus obtained, in which h-BN particles were adhered to AlN particles (AlN particles were modified with h-BN particles) via the resin.

### (2) Samples 21 to 24

Composite particles of Samples 21 to 24 were also produced in the same steps as those for Sample 1 except that the cleaved powder used in producing Sample 1 was replaced with the following h-BN powders.
Sample 21: HGP available from Denka Company Limited/D50: 5 μm, AR: 4
Sample 22: GP available from Denka Company Limited/D50: 10 μm, AR: 5
Sample 23: SGP available from Denka Company Limited/D50: 20 μm, AR: 10
Sample 24: PT110 available from Momentive Performance Materials/D50: 45 μm, AR: 18

### (3) Sample CO

A filler was also prepared, which was produced through the same steps as those for Sample 1 except that the epoxy resin used in the production of Sample 1 was not added.

### (4) Sample C1

A powder obtained by simply mixing the following raw material powders using the above-described mixer was used as a filler.
Coarse AlN powder (FAN-f50 available from Furukawa Denshi Co., Ltd.): 2.18 g
Fine AlN powder (FAN-f05 available from Furukawa Denshi Co., Ltd.): 0.94 g
(Circularity: 0.90, D50: 5 μm)

Above-described h-BN cleaved powder: 0.92g

The volume ratio of the mixed powder was set to be the total amount of coarse AlN powder and fine AlN powder: h-BN cleaved powder=7:3.

### (5) Sample C2

A powder obtained by simply mixing the above-described coarse AlN powder and fine AlN powder at a volume ratio of 7:3 was used as a filler. Mixing was performed in the same manner as in Sample C1.

### (6) Sample C3

The above-described coarse AlN powder was used as a filler without any modification.

### «Production of Composite Materials»

A composite material was produced, in which the filler was held in a matrix. Unless otherwise stated, the filling rate of the filler was 70 vol % with respect to the entire composite material (100 vol %). The epoxy resin (EP-160 available from CEMEDINE CO., LTD./simply referred to as a “resin”) used in the production of the composite particles was used as the matrix (binder). The specific steps are as follows.

The filler and resin were kneaded in a plastic container for 10 minutes. The vacuum-dried kneaded material was disintegrated to obtain a compound in which the resin was attached to the filler. This compound was filled into a mold and compression molded in a uniaxial direction. In this operation, the mold temperature was 130° C., the molding pressure was 20 MPa, and the pressurized state was maintained for 30 minutes to thermally cure the resin. Through this operation, a cylindrical composite (φ14 mm×20 mm) in which the filler was held by the resin was obtained. In the present example, unless otherwise stated, the filler and the composite material using the filler are referred to by the same sample number (here and hereinafter).

### «Observation»

The cross section of the compact obtained during the production of the filler of Sample 1 before pulverization was observed using a scanning electron microscope (SEM). The SEM image is shown in FIG. 2A.

The SEM images of the filler (composite particles) of Sample 1 are shown in FIG. 2A. The SEM image of the composite particle and the EDX analysis image obtained by elemental analysis of the composite particle using energy dispersive X-ray spectroscopy (EDX) are shown together in FIG. 2C. The coverage of the AlN particles by the h-BN particles calculated from FIG. 2C was about 84%.

The SEM image of the filler of Sample CO is shown in FIG. 3.

### «Measurement»

The thermal conductivity (2) of the composite material was determined by the nanoflash method (measuring device: LFA447 available from NETZSCH). Specifically, the thermal conductivity was calculated as λ=α·Cp·ρ from a thermal diffusivity (α) measured by the nanoflash method, a specific heat (Cp) determined by the differential scanning calorimeter (DSC), and a density (φ determined by the Archimedes method.

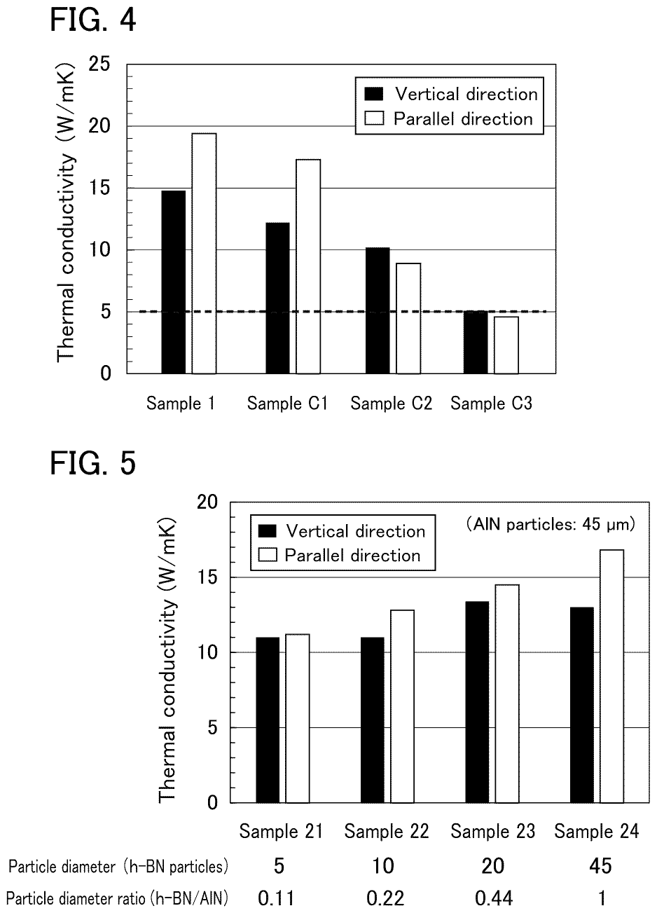

For the measurement of the thermal diffusivity, a thin plate-shaped sample (referred to as a “vertical sample”) cut out from a cylindrical composite material in a direction perpendicular to the axial direction (pressing direction) and a thin plate-shaped sample (referred to as a “parallel sample”) cut out in a direction parallel to the axial direction were used. FIG. 4 illustrates the thermal conductivities of the composite materials of Sample 1 and Samples C1 to C3. FIG. 5 illustrates the thermal conductivities of the composite materials of Samples 21 to 24. The “vertical direction” and “parallel direction” noted in each figure mean the thermal conductivity of the vertical sample and the thermal conductivity of the parallel sample, respectively.

### «Evaluation»

### (1) Filler

As apparent from FIGS. 2A to 2C (collectively referred to as “FIG. 2”), it has been found that the filler of Sample 1 is composed of composite particles in which the flat h-BN particles (adherent particles) are tightly adhered to the surfaces of the spherical AlN particles (base particles) via a thin resin layer.

On the other hand, as apparent from FIG. 3, the filler of sample CO to which no resin was added during the production was in a state in which the spherical AlN particles and the flat h-BN particles (adherent particles) were almost separated.

### (2) Thermal Conductivity of Composite Material

As apparent from FIGS. 4 and 5, all of the composite materials of Sample 1 and Samples 21 to 24, in which the composite particles were used as fillers, had high thermal conductivities both in the vertical direction and the parallel direction, unlike the composite materials of other samples. In other words, it has been found that the composite materials containing the composite particles as fillers have excellent thermal conductivity and small anisotropy.

Moreover, as apparent from FIG. 5, the composite materials containing the composite particles in which the particle diameter ratio of h-BN particles to AlN particles is at least 1 or less had a thermal conductivity of 10 W/mK or more in both the vertical direction and the parallel direction.

### «Consideration»

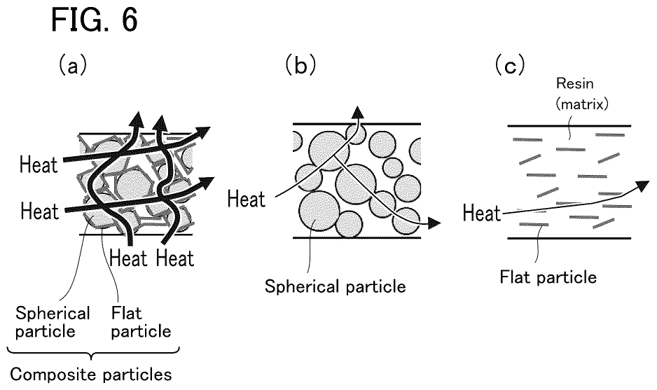

In view of the above-described results, it can be said that the form (structure) of the filler had a large influence on the thermal conductivity of the composite material. This mechanism is inferred as illustrated in FIG. 6. That is, as illustrated in FIG. 6(a), in the composite particles in which the flat adherent particles are adhered to the surfaces of the spherical base particles, the particles come into approximate surface contact with each other at various locations, and sufficient thermal conduction paths can be formed approximately isotropically. This appears to allow the composite material containing the composite particles to develop excellent thermal conductivity approximately isotropically.

On the other hand, as illustrated in FIG. 6(b), in the case of a filler consisting only of spherical particles, the contact fraction (contact ratio) between the particles was small in the first place, and the contact form between the particles was a point contact. Moreover, as illustrated in FIG. 6(c), also in the case of a filler consisting only of flat particles, the contact ratio between the particles was small, and the particles were oriented in one direction. Thus, with conventional composite materials, it is difficult to form sufficient thermal conduction paths in the first place, and it can be considered that high thermal conductivity was not able to be developed. Even if the filling rate of the flat particles was increased, the direction of thermal conduction would be restricted, and it can be considered that high thermal conductivity was not able to be achieved isotropically.

### Second Example

### «Production of Fillers»

Multiple types of fillers illustrated below were produced.

### (1) Sample 31

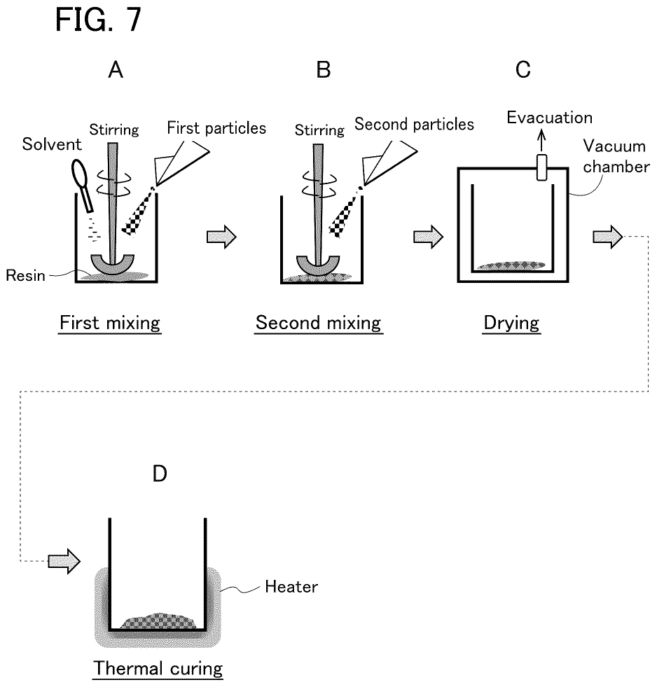

The previously described AlN powder (FAN-f50 available from Furukawa Denshi Co., Ltd.), h-BN powder (HGP available from Denka Company Limited/particle diameter ratio: 0.11), and epoxy resin (EP-160 available from CEMEDINE CO., LTD.) were used as raw materials, and each step illustrated in FIG. 7 was performed to prepare composite particles. Specifically, it is as follows.

In a polypropylene container, 1-10 cc of solvent (dichloromethane) and 3 g of AlN powder were added to 0.35 g of epoxy resin, and they were stirred and mixed at room temperature (Step A/First mixing step). In this step, the mixer (ARE-310 “Rentaro” available from THINKY CORPORATION) was operated at 2000 rpm×0.5 min.

To the mixture (first mixture) in the container, 1.4 g of the h-BN powder was added, and they were stirred and kneaded at room temperature (Step B/Second mixing step). Also in this operation, the mixer was operated at 2000 rpm×0.5 min. The transition from Step A to Step B was performed continuously without stopping the mixer.

The volume fractions of the AlN particles (true density: 3.3 g/cm³) and the h-BN particles (true density: 2.27 g/cm³) are AlN particles (first particles): h-BN particles (second particles)-6:4 (volume ratio of the adherent particles to the total of both particles: 0.4). The epoxy resin (true density: 1.16 g/cm³) is 16 vol % with respect to the entire mixture.

The obtained kneaded product (second mixture) was placed in a vacuum chamber and vacuum dried (30 minutes) at room temperature (Step C/Drying step). The dried kneaded product was heated at 120-150° C. (epoxy resin curing temperature Tc to Tc+30° C.) for 20 minutes (Step D/Thermal curing step).

The heated kneaded product was disintegrated using a tabletop pulverizer (WB-1 available from OSAKA CHEMICAL Co., Ltd.). The disintegrated powder was sieved to adjust the granularity to less than 53 μm. Composite particles were thus obtained, in which h-BN particles were adhered to AlN particles (AlN particles were modified with h-BN particles) via the resin.

### (2) Sample 41

Composite particles were produced in the same steps as those for Sample 31 except that the AlN powder was replaced with Al₂O₃powder (CB-A50S available from Showa Denko K.K.). The Al₂O₃ powder was composed of spherical particles (first particles) with a circularity of 0.9 and a particle diameter (D50) of 50 μm. At that time, the particle diameter ratio (h-BN particles/Al₂O₃ particles) was 0.10.

The formulation of raw materials was 0.14 g of epoxy resin, 3.6 g of Al₂O₃ powder, and 1.4 g of h-BN powder. Since Al₂O₃ particles have a true density of 3.95 g/cm³, Al₂O₃ particles (first particles): h-BN particles (second particles)=6:4 (volume ratio of the adherent particles to the total of both particles: 0.4). The epoxy resin is 7 vol % with respect to the entire mixture.

### (3) Sample 32 and Sample 42

Composite particles produced in the same manner as in the first example were also prepared using the same raw materials as those for Sample 31 (Sample 32). Sample 32 and Sample 21 described previously have the same raw materials and the same steps, but differ in the volume proportions of AlN particles, h-BN particles, and epoxy resin.

Composite particles produced in the same manner as in the first example were also prepared using the same raw materials as those for Sample 41 (Sample 42).

### (4) Sample C3 and Sample C4

For Sample C3 (same as in the first example) and Sample C4, the above-described AlN powder and Al₂O₃ powder were used as fillers without any modification, respectively.

### «Production of Composite Materials»

A composite material in which the filler composed of composite particles of each sample was held in a matrix composed of an epoxy resin was produced in the same manner as in the first example.

Other than EP-160 available from CEMEDINE CO., LTD., for example, EP-106NL available from CEMEDINE CO., LTD. may also be used as the epoxy resin. The latter has a lower viscosity (about ⅕) than the former, so it can be readily kneaded with the filler, and the dispersibility of the composite particles in the matrix can also be improved.

### «Observation»

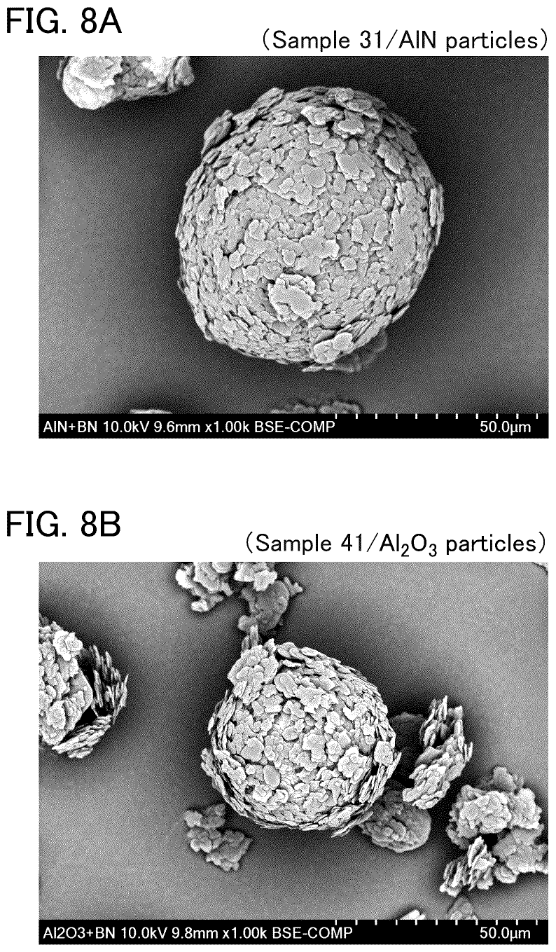

SEM images when observing the fillers (composite particles) of Sample 31 and Sample 41 are shown in FIGS. 8A and 8B (both are collectively referred to as “FIG. 8”), respectively.

Each composite particle was subjected to elemental analysis by EDX in the same manner as in the first example. As a result, the coverage of Sample 31 was about 95%, and the coverage of Sample 41 was about 90%.

### «Measurement»

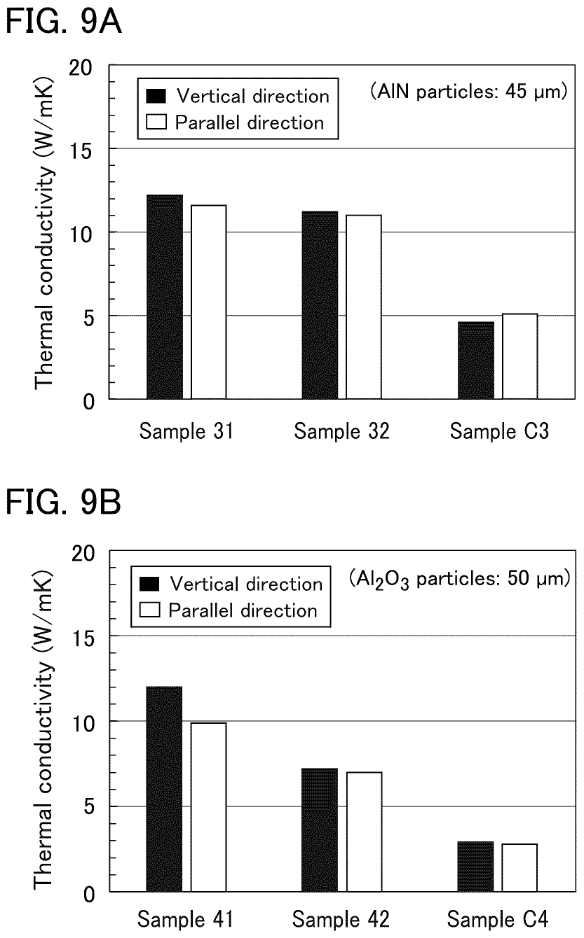

The thermal conductivity of the composite material of each sample was measured in the same manner as in the first example. The results are illustrated in FIGS. 9A and 9B (both are collectively referred to as “FIG. 9”).

### «Evaluation»

### (1) Filler

As can be seen from FIG. 8, also in the manufacturing method of the present example, it has been found that approximately spherical composite particles are obtained in which flat h-BN particles (adherent particles) are densely adhered to the surfaces of spherical base particles (AlN particles or Al₂O₃ particles) via the resin layer.

### (2) Composite Material

As can be seen from FIG. 9, the composite materials containing composite particles as fillers (Samples 31, 32, 41, and 42) had high thermal conductivity in both the vertical direction and the parallel direction. Suffice it to say that the thermal conductivities of the composite materials according to the present example (Samples 31 and 41) tended to be higher than those of the composite materials according to the first example (Samples 32 and 42). This tendency was remarkable when the base particles were Al₂O₃ particles (see FIG. 9B). In all samples, the difference in thermal conductivity between the vertical direction and the parallel direction was small (less than 3 W/mK).

### Third Example

As listed in Table 1, a number of fillers and composite materials using the fillers were produced, and the properties of the composite materials were evaluated. The present invention will be described in more detail while illustrating such examples.

### «Production of Fillers»

### <Samples 511 to 532>

The fillers of Samples 511 to 532 listed in Table 1 are composed of (secondary) composite particles in which third particles serving as crosslinking particles are further adhered to (primary) composite particles illustrated in the second example. Such secondary composite particles were produced as follows.

### (1) Raw Materials

For the first particles, AlN powder (FAN-f80 available from Furukawa Denshi Co., Ltd./Circularity: 0.90) having a particle diameter (L1) of 80 μm was used. Unless otherwise stated, the particle diameter is the median diameter (D50) (here and hereinafter).

For the second particles, any of the h-BN powders illustrated below having different particle diameters (L2) was used.

Particle diameter: 5 μm/HGP available from Denka Company Limited

Particle diameter: 10 μm/MGP available from Denka Company Limited

Particle diameter: 13 μm/HGP+MGP available from Denka Company Limited (mixed powder of the above powders)

For the third particles, any of the h-BN powders illustrated below having different particle diameters (L3) was used.

Particle diameter: 20 μm/SGP available from Denka Company Limited

Particle diameter: 40 μm/PT110 available from Momentive Performance

### Materials

For the resin, epoxy resin (EP-160 available from CEMEDINE CO., LTD.) was used.

### (2) Steps

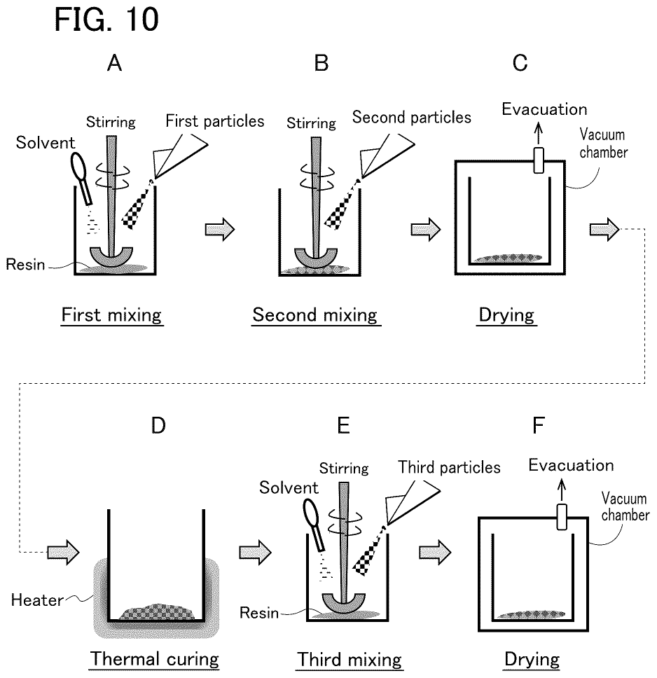

Raw materials weighed in the compounding amounts (vol %) listed in Table 1 were subjected to each step illustrated in FIG. 10. Specifically, it is as follows.

In a polypropylene container, solvent (dichloromethane: 1-10 cc) and the first particles (AlN powder) were added to epoxy resin, and they were stirred and mixed at room temperature (Step A/First mixing step). Mixing was performed by operating the mixer at 2000 rpm×0.5 min in the same manner as in the second example. The amount of resin (vol %) added to the entire mixture (first particles, second particles, third particles, and resin) in the first mixing step is also listed in Table 1.

The second particles (h-BN powder) were added to the mixture (first mixture) in the container, and they were stirred and kneaded at room temperature (Step B/Second mixing step). The transition from Step A to Step B was performed while operating the mixer at 2000 rpm×0.5 min.

The obtained kneaded product (second mixture) was placed in a vacuum chamber and vacuum dried (30 minutes) at room temperature (Step C/First drying step). The dried kneaded product was heated at 120-150° C. (epoxy resin curing temperature Tc to Tc+30° C.) for 20 minutes (Step D/Thermal curing step). Composite particles (referred to as “primary composite particles”) were thus obtained, in which the second particles (h-BN particles) were adhered to the first particles (AlN particles) (AlN particles were modified with h-BN particles) via the resin.

Furthermore, third particles (h-BN powder) were added to the primary composite particles in the above-described container, and they were stirred and mixed at room temperature (Step E/Third mixing step). This mixing was performed in the same manner as the first mixing step while adding a solvent (dichloromethane: 1-10 cc) to the epoxy resin. Table 1 also lists the amount of resin (vol %) added to the entire mixture (first particles, second particles, third particles, and resin) in the third mixing step.

The obtained kneaded product (third mixture) was placed in a vacuum chamber and vacuum dried (30 minutes) at room temperature (Step F/Second drying step). Composite particles (referred to as “secondary composite particles”) were thus obtained, in which the second particles (fine h-BN particles) and the third particles (coarse h-BN particles) were adhered to the first particles (AlN particles) (the first particles were modified with the second particles and the third particles) via the resin.

### <Samples 611 to 631>

Fillers of Samples 611 to 631 were prepared using the raw materials (first particles, second particles, and resin) weighed in the volume proportions listed in Table 1 without performing the above-described third mixing step and subsequent step. In other words, the fillers of Samples 611 to 631 are composed of primary composite particles obtained by performing the previous steps as described above.

### <Samples C51 and C52>

Fillers of Samples C51 and C52 were prepared using the raw materials (first particles and resin) weighed in the volume proportions listed in Table 1 without performing the above-described second mixing step and subsequent steps. In other words, the fillers of Samples C51 and C52 are composed of the mixtures obtained after the first mixing step. In this operation, the first mixing step and the like were performed as described previously.

### «Production of Composite Materials»

A composite material in which the filler of each sample was held in an epoxy resin (matrix) was produced in the same manner as in the first example. However, the amount of resin in the matrix with respect to the entire composite material (100 vol %) was Sample 513:10 vol %, Sample 511, 512, and 514-532:20 vol %, Sample C51: 30 vol %, and Sample C52: 20 vol %.

### «Measurement»

### (1) Thermal Conductivity

The thermal conductivities of the composite materials were measured in the same manner as in the first example. Table 1 also lists the thermal conductivities of parallel samples cut out from the composite materials.

### (2) Porosity

The porosities of the composite materials are also listed in Table 1. The porosity was determined from the (true) density (ρ) and theoretical density φth) of the composite material as {(ρth-φ/ρth}×100(%). The (true) density p was calculated from the mass and volume actually measured for the composite material (Archimedes method). The theoretical density ρth was calculated based on the compounding ratio and density of each raw material (particles and resin) used to produce the composite material.

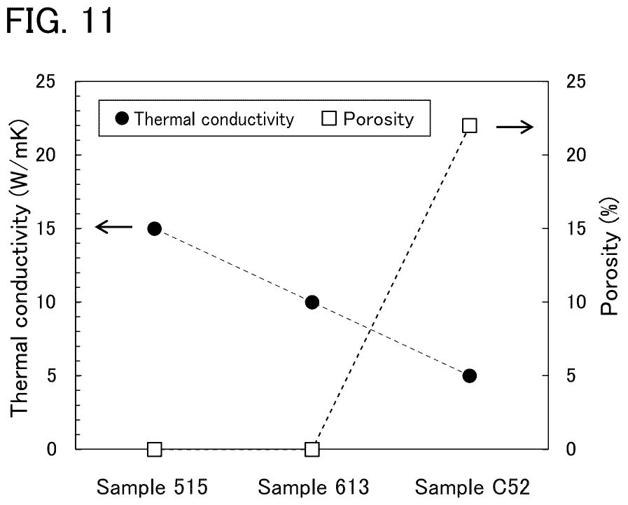

The thermal conductivity and porosity of Sample 515, Sample 613, and Sample C52 are illustrated in comparison in FIG. 11.

### «Observation»

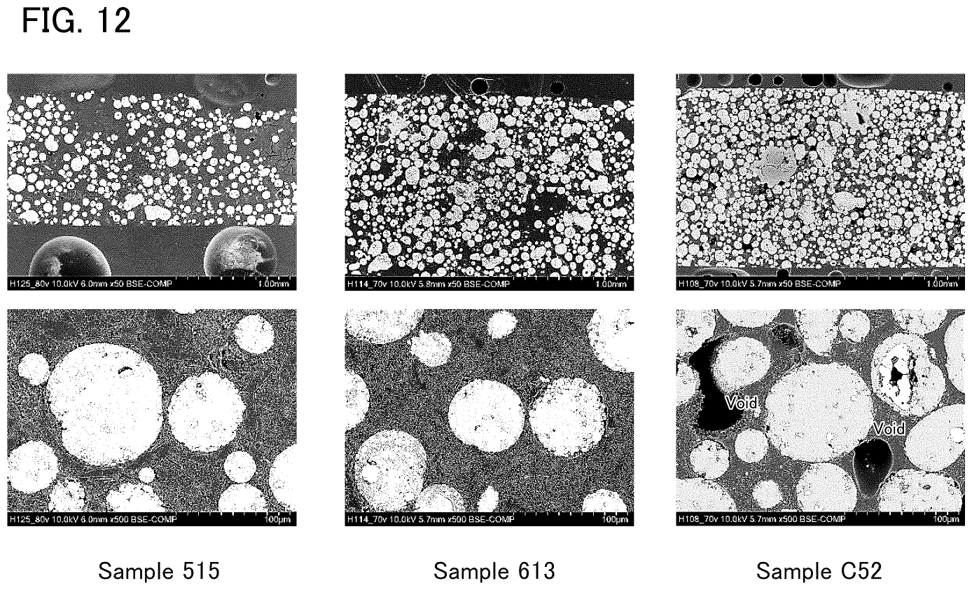

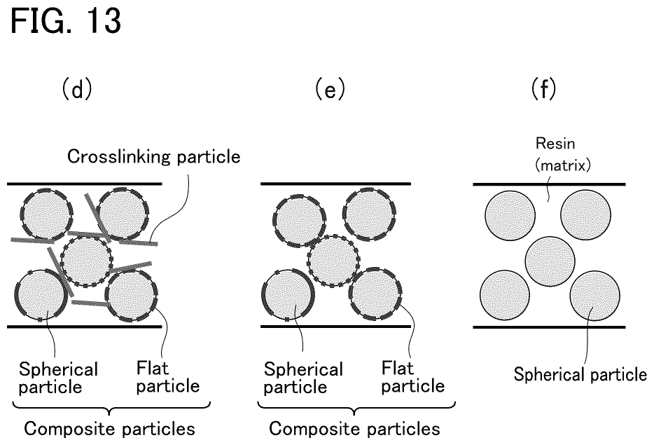

FIG. 12 shows SEM images of the cross sections (planes parallel to the pressing direction during the molding of the composite materials) according to the composite materials of Sample 515, Sample 613, and Sample C52. FIG. 13 schematically illustrates the appearance of the filler in each composite material based on a SEM image.

### «Evaluation»

As found from Table 1 and FIG. 11, the samples (Samples 511 to 532 and Samples 611 to 631) containing the (primary) composite particles in which the flat second particles (adherent particles) are adhered to the surfaces of the approximately spherical first particles (base particles) with the resin had sufficiently small porosity and exhibited high thermal conductivity. This tendency was remarkable in Samples 511 to 532 containing the (secondary) composite particles to which the third particles (crosslinking particles) were attached to the outermost surfaces.

On the other hand, Samples C51 and C52 in which the approximately spherical base particles were used as the fillers had large porosity (see FIG. 12) and low thermal conductivity.

### «Consideration»

The reason why the thermal conductivity was significantly improved by using the secondary composite particles having the crosslinking particles (third particles) as the filler is inferred from FIGS. 12 and 13 as follows.

As illustrated in FIG. 13(f), in a composite material containing only approximately spherical base particles as the filler, contact between the particles is poor, and even when contact occurs, the contact is point-like. It is therefore difficult to form thermal conduction paths that penetrate the composite material.

As illustrated in FIG. 13(e), in a composite material containing as the filler the primary composite particles having the flat adherent particles on the surfaces of the approximately spherical base particles, planar contact between the composite particles tends to occur, and thermal conduction paths that penetrate the composite material increase.

As illustrated in FIG. 13(d), in a composite material containing as the filler the secondary composite particles having the crosslinking particles with a larger particle diameter than the adherent particles on the outermost surface side, the crosslinking particles cooperate between the composite particles in addition to the planar contact between the composite particles. This allows a large number of thermal conduction paths to be formed isotropically between the composite particles, and it is considered that the thermal conductivity of the composite material increased significantly.

From the above, it has been revealed that the thermally conductive material (filler or composite material) of the present invention ensures approximately isotropic and high thermal conductivity.

TABLE 1

| | Filler | | | | | | | | |
|---|---|---|---|---|---|---|---|---|---|
| | First particles | | Second particles | | Third particles | | | | |
| | (base particles) | | (adherent particles) | | (crosslinking particles) | | Resin | | |
| | Particle | Compounding | Particle | Compounding | Particle | Compounding | During | During | |
| | diameter | amount | diameter | amount | diameter | amount | first | third | |
| Sample | L1 | V1 | L2 | V2 | L3 | V3 | mixing | mixing | Total |
| No. | (μm) | (vol %) | (μm) | (vol %) | (μm) | (vol %) | (vol %) | (vol %) | (vol %) |
| 511 | 80 | 60 | 5 | 15 | 20 | 5 | 5 | 5 | 10 |
| 512 | | 53 | | 22 | | 5 | 5 | 5 | 10 |
| 513 | | 70 | | 10 | 20 | 10 | 5 | 0 | 5 |
| 514 | | 55 | | 15 | 20 | 10 | 5 | 5 | 10 |
| 515 | | 55 | | 15 | 40 | 10 | 5 | 5 | 10 |
| 521 | | 55 | 10 | 15 | 20 | 10 | 5 | 5 | 10 |
| 522 | | 55 | | 15 | 40 | 10 | 5 | 5 | 10 |
| 531 | | 55 | 13 | 15 | 20 | 10 | 5 | 5 | 10 |
| 532 | | 55 | | 15 | 40 | 10 | 5 | 5 | 10 |
| 611 | 80 | 65 | 5 | 15 | — | | 20 | — | 20 |
| 612 | | 60 | | 15 | | | 25 | | 25 |
| 613 | | 53 | | 22 | | | 25 | | 25 |
| 614 | | 55 | | 15 | | | 30 | | 30 |
| 621 | | 55 | 10 | 15 | | | 30 | | 30 |
| 631 | | 55 | 13 | 15 | | | 30 | | 30 |
| C51 | 80 | 70 | — | | — | | — | | |
| C52 | | 80 | | | | | | | |

| | Filler | | | | | |
|---|---|---|---|---|---|---|
| | | | Volume ratio | | Composite material | |
| Sample | Particle diameter ratio | | (Vt = V1 + V2+ V3) | | Thermal conductivity | Porosity |
| No. | L2/L1 | L3/L2 | V1/Vt | V3/V2 | (W/mK) | (%) |
| 511 | 0.06 | 4 | 0.75 | 0.33 | 13 | 2 |
| 512 | | | 0.66 | 0.23 | 11 | 6 |
| 513 | | 4 | 0.78 | 1.00 | 14 | 7 |
| 514 | | 4 | 0.69 | 0.67 | 14 | 1 |
| 515 | | 8 | 0.69 | 0.67 | 15 | 0 |
| 521 | 0.13 | 2 | 0.69 | 0.67 | 15 | 1 |
| 522 | | 4 | 0.69 | 0.67 | 15 | 2 |
| 531 | 0.16 | 1.54 | 0.69 | 0.67 | 14 | 3 |
| 532 | | 3.08 | 0.69 | 0.67 | 15 | 3 |
| 611 | 0.06 | — | 0.81 | — | 10 | 5 |
| 612 | | | 0.80 | | 10 | 1 |
| 613 | | | 0.71 | | 10 | 0 |
| 614 | | | 0.79 | | 9 | 6 |
| 621 | 0.13 | | 0.79 | | 7 | 6 |
| 631 | 0.16 | | 0.79 | | 7 | 6 |
| C51 | — | — | — | — | 6 | 12 |
| C52 | | | | | 5 | 22 |

1. A thermally conductive material comprising composite particles having approximately spherical base particles and flat adherent particles adhered to surfaces of the base particles via a resin.

2. The thermally conductive material according to claim 1, wherein a particle diameter ratio (L2/L1) that is a ratio of a particle diameter (L2) of the adherent particles to a particle diameter (L1) of the base particles is 0.01-2.

3. The thermally conductive material according to claim 1, wherein the base particles have a volume ratio of 0.5-0.9 with respect to a total amount of the base particles and the adherent particles.

4. The thermally conductive material according to claim 1, wherein the adherent particles are composed of hexagonal boron nitride.

5. The thermally conductive material according to claim 1, wherein the base particles are composed of one or more of aluminum nitride, aluminum oxide, silicon oxide, and cubic boron nitride.

6. The thermally conductive material according to claim 1, wherein the composite particles are composed of a composite material dispersed in a matrix.

7. The thermally conductive material according to claim 6, wherein the composite material further includes crosslinking particles having a larger particle diameter than the adherent particles.

8. The thermally conductive material according to claim 1, wherein the composite particles further have crosslinking particles having a larger particle diameter than the adherent particles on the surface side.

9. The thermally conductive material according to claim 8, wherein the base particles have a volume ratio of 0.4-0.85 with respect to a total amount of the base particles, the adherent particles, and the crosslinking particles.

10. The thermally conductive material according to claim 8, wherein the crosslinking particles are composed of hexagonal boron nitride.

11. The thermally conductive material according to claim 8, wherein the composite particles are composed of a composite material dispersed in a matrix.

12. A method of manufacturing a thermally conductive material, comprising:
a preparation step of obtaining a mixture in which approximately spherical first particles, flat second particles, and a resin are mixed;
a molding step of pressurizing the mixture to obtain a compact; and
a pulverization step of pulverizing the compact,
wherein composite particles are obtained in which the second particles are adhered to surfaces of the first particles by the resin.

13. The method of manufacturing a thermally conductive material according to claim 12, wherein the molding step is performed in a state in which the resin is softened or melted.

14. A method of manufacturing a thermally conductive material, comprising:
a first mixing step of obtaining a first mixture in which approximately spherical first particles and a resin are mixed; and
a second mixing step of obtaining a second mixture in which the first mixture and flat second particles are mixed,
wherein composite particles are obtained in which the second particles are adhered to surfaces of the first particles by the resin.

15. A method of manufacturing a thermally conductive material, comprising:
a first mixing step of obtaining a first mixture in which approximately spherical first particles and a resin are mixed;
a second mixing step of obtaining a second mixture in which the first mixture and flat second particles are mixed; and
a third mixing step of obtaining a third mixture in which the second mixture and third particles having a larger particle diameter than the second particles are mixed,
wherein composite particles are obtained in which the second particles are adhered to surfaces of the first particles by the resin and the third particles are attached to the surface side.

16. The method of manufacturing a thermally conductive material according to claim 14, wherein the resin is a thermosetting resin, and
the method further comprises a thermal curing step of heating the second mixture to cure the resin between the first particles and the second particles.
